(19) United States
(12) Patent Application Publication
(10) Pub. No.: US 2012/0092487 A1
(43) Pub. Date: Apr. 19, 2012

(54) LIGHT PATH RESTRICTING STRUCTURE

(75) Inventor: Chih-Chiang Lee, Taoyuan County (TW)

(73) Assignee: CHUNGHWA PICTURE TUBES, LTD., Taoyuan (TW)

(21) Appl. No.: 13/031,303

(22) Filed: Feb. 21, 2011

(30) Foreign Application Priority Data
Oct. 15, 2010 (TW) 099219981

(51) Int. Cl. H04N 7/18

(52) U.S. Cl. 348/125; 348/E07.085

(57) ABSTRACT

A light path restricting structure is provided, which is applicable in an optical inspection equipment including a light source module for providing a linear light source, a linear camera, a light-splitting unit for refracting light of the linear light source to an object to be inspected and the linear camera, a conveying mechanism for driving the object to be inspected to move, and a case for accommodating the elements. The light path restricting structure is disposed on a transmission path of the linear light source. The light path restricting structure includes a body, which includes a first surface facing the linear light source of the light source module and a second surface facing the linear camera. A plurality of light channels is disposed in the body, and each light channel includes a light inlet and a light outlet disposed on the first surface and the second surface of the body.

### CROSS-REFERENCE TO RELATED APPLICATION

This application claims the benefit of Taiwan Patent Application No. 099219981, filed on Oct. 15, 2010, which is hereby incorporated by reference for all purposes as if fully set forth herein.

### BACKGROUND OF THE INVENTION

1. Field of Invention

The present invention relates to a light shielding structure, and more particularly to a light path restricting structure for only maintaining linear light channels between a light source module and a linear camera in an optical inspection equipment.

2. Related Art

In the prior art, an automatic optical inspection equipment is often used for defect inspection of various equipment, circuit boards, elements, liquid crystal panels, and semiconductors. For example, in a thin film transistor (TFT) process, the automatic optical inspection equipment is often used, in combination with a line scan camera (Charge Coupled Device, CCD), in processes such as array line inspection for panels or circuit boards, polyimide coating inspection for elements, and sealant breakage inspection.

However, in the automatic optical inspection equipment, a light source module is often used in combination with the line scan camera, when the object to be inspected has protrusions or a height difference exists relative to the background, non-directional reflected light is generated when the light provided by the light source module is projected on the protrusions, and since the transmission direction of the object to be inspected is perpendicular to the linear shooting range of the line scan camera, the line scan camera receives the non-directional reflected light, which leads to poor contrast of formed images, and thus the images are not clear. As a result, the automatic optical inspection equipment makes a false determination of actual path configuration or sealant configuration, which not only affects the inspection yield and accuracy of the object to be inspected, but also delays the whole inspection process.

### SUMMARY OF THE INVENTION

The present invention is directed to a light path restricting structure, which is disposed in an optical inspection equipment and is used for shielding divergent light at other angles to only maintain linear light channels between a light source module and a light-splitting unit or an object to be inspected.

In order to solve the above problems, the present invention provides a light path restricting structure, which is applicable in an optical inspection equipment. The optical inspection equipment comprises a light source module for providing a linear light source, a linear camera, a light-splitting unit for refracting light of the linear light source to an object to be inspected and the linear camera, a conveying mechanism for driving the object to be inspected to move, an operation module for driving the linear camera, the conveying mechanism and the light source module, and a case for accommodating the linear camera, the conveying mechanism, the light-splitting unit and the light source module. The light path restricting structure is disposed between the light source module and the light-splitting unit, and is located on a projection path of the linear light source. The light path restricting structure comprises a body and a plurality of light channels.

The body comprises a first surface facing the light source module and a second surface facing the light-splitting unit. All the light channels are disposed in the body in a linear manner, and each light channel comprises a light source inlet and a light source outlet. Each light source inlet is disposed on the first surface, and at a position corresponding to an emitting site of the linear light source, and each light source outlet is disposed on the second surface, and at a position corresponding to the light-splitting unit.

In order to solve the above problems, the present invention provides another light path restricting structure, which is applicable in an optical inspection equipment. The optical inspection equipment comprises a light source module for projecting a linear light source to an object to be inspected, a linear camera for receiving reflected light generated by projecting the linear light source to the object to be inspected, a conveying mechanism for driving the object to be inspected to move, an operation module for driving the linear camera, the conveying mechanism and the light source module, and a case. The case is used for accommodating the light source module, the conveying mechanism and the linear camera. The light path restricting structure is disposed between the light source module and the object to be inspected, and is located on a projection path of the linear light source. The light path restricting structure comprises a body and a plurality of light channels.

The body comprises a first surface facing the light source module and a second surface facing the object to be inspected. The light channels are disposed in the body in a linear manner, and each light channel comprises a light source inlet and a light source outlet. Each light source inlet is disposed on the first surface, and at a position corresponding to an emitting site of the linear light source, and each light source outlet is disposed on the second surface, and at a position corresponding to the object to be inspected.

The present invention is characterized in that, the linear light paths from the light source module to the light-splitting unit or the object to be inspected are maintained by the light channels, and meanwhile the divergent light at other angles emitted by the light source module is shield, such that the light-splitting unit will merely receive the light transmitted by the light channels, or the linear camera will merely receive the reflected light reflected by the object to be inspected, but not receive the divergent light at other angles emitted by the light source module or the reflected light at other angles reflected by the object to be inspected. Therefore, images finally formed by the linear camera will not have blurred patterns with poor contrast, and the automatic optical inspection equipment can also reduce the possibility of false determinations due to poor contrast of the pattern when inspecting defects of actual line configuration or sealant configuration, thereby improving the inspection yield and accuracy of the object to be inspected, and further accelerating the inspection procedure of the object to be inspected.

### BRIEF DESCRIPTION OF THE DRAWINGS

The present invention will become more fully understood from the detailed description given herein below for illustration only, and thus are not limitative of the present invention, and wherein:

FIG. 1 is a schematic structural view of a light path restricting structure according to an embodiment of the present invention;

FIG. 2 is a schematic view of a first configuration of a light path restricting structure according to an embodiment of the present invention;

FIG. 3 is a schematic view of a second configuration of a light path restricting structure according to an embodiment of the present invention;

FIG. 4 is a schematic view of light path restriction according to an embodiment of the present invention;

FIG. 5 is a schematic view of light refraction according to an embodiment of the present invention;

FIG. 6 is a schematic view of range estimation of an inclined angle of light channels of a light path restricting structure according to an embodiment of the present invention; and

FIG. 7A and FIG. 7B are schematic views of formed images according to an embodiment of the present invention.

### DETAILED DESCRIPTION OF THE INVENTION

Hereinafter, preferred embodiments of the present invention are described in detail with reference to the accompanying drawings.

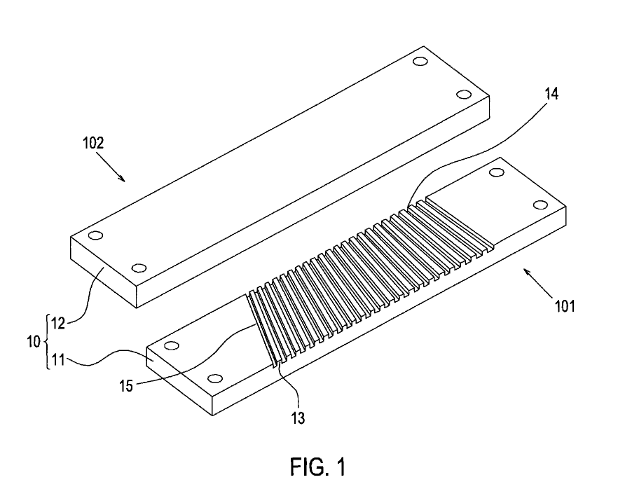

FIG. 1 is a schematic structural view of a light path restricting structure according to an embodiment of the present invention. Referring to FIG. 1, in the light path restricting structure of this embodiment, a body 10 includes a first block 11 and a second block 12 bonded to each other. A surface of the first block 11 has a plurality of linear groove-like light channels 15 disposed thereon. In this embodiment, all the light channels 15 are disposed on the first block 11, and form a trapezoid with one end wider than the other end. That is to say, openings at one end of the first block 11 are distributed loosely, and openings at the other end of the first block 11 are disposed densely.

The light channels 15 are concealed between the first block 11 and the second block 12 as tubular channels when the first block 11 and the second block 12 overlap. Each light channel 15 includes a light source inlet 13 and a light source outlet 14. The light source inlet 13 and the light source outlet 14 are individually disposed on a first surface 101 and a second surface 102 of the body 10. Herein, the openings exposed at the first surface 101 are light source inlets 13, and the openings exposed at the second surface 102 are light source outlets 14.

The cross-sectional shape of each light channel 15 may be a circle or a polygon, in which the polygon may also be a triangle, a quadrilateral, a pentagon, or a hexagon. Moreover, the cross-sectional shape of the light channel 15 may also be, but is not limited to, other similar polygons.

However, the open light channels 15 may also be designed on the surface of the second block 12, or designed on the first block 11 and the second block 12 at the same time, but the present invention is not limited to the design on the first block 11. Moreover, the body 10 and the light channels 15 may be integrated to form a unity. Furthermore, the material of the body 10 is a light absorbing material or an opaque material. The light absorbing material is, for example, wood, dark plastic, or other solid materials with dark appearance, and the opaque material is, for example, a non-light transmissive material, such as, plastic, iron, copper, or aluminum.

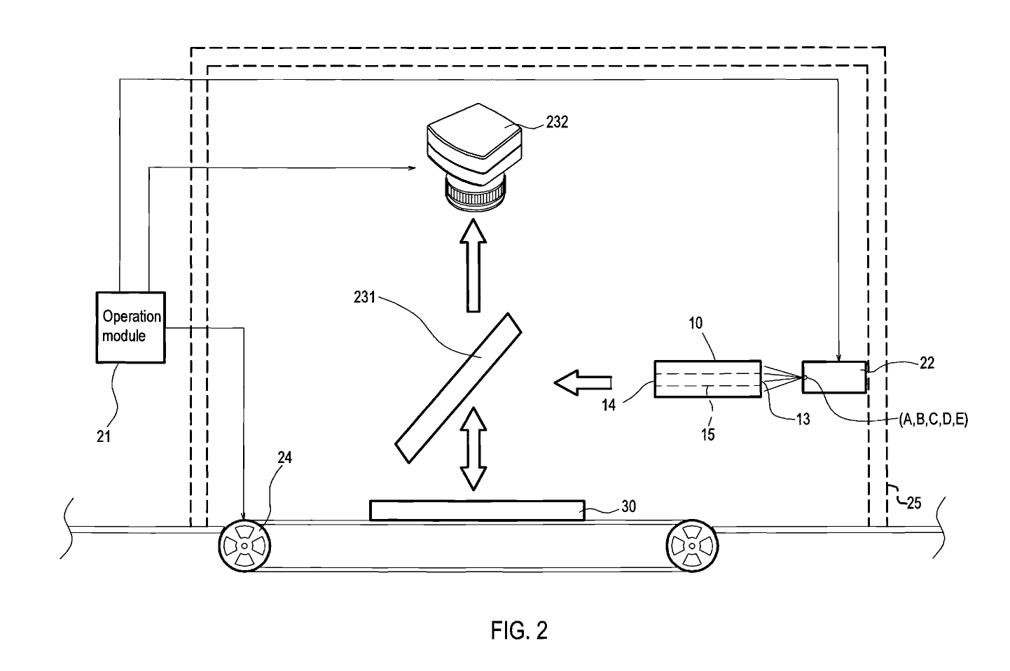

FIG. 2 is a schematic view of a first configuration of a light path restricting structure according to an embodiment of the present invention. Referring to FIG. 1 and FIG. 2, the light path restricting structure is applicable in an optical inspection equipment, and the optical inspection equipment includes an operation module 21, a light source module 22 for providing a linear light source, a conveying mechanism 24, a light-splitting unit 231, a linear camera 232, and a case 25. The case 25 is used for accommodating the light source module 22, the conveying mechanism 24, the linear camera 232, and the light-splitting unit 231, so as to avoid the formation of undesired images due to influence of other external light sources when the linear camera 232 captures an image of the object to be inspected 30.

In this embodiment, a lens of the linear camera 232 faces the object to be inspected 30, the light-splitting unit 231 is disposed between the linear camera 232 and the object to be inspected 30, and a projection direction of the light source of the light source module 22 is toward the light-splitting unit 231. Herein, it should be noted that, arrows in FIG. 2 represent light transmission directions.

In this embodiment, the light source module 22 provides more than one light source (A, B, C, D, and E), so as to form a linear light source and project the linear light source to the light-splitting unit 231. The light-splitting unit 231 refracts the received light to the object to be inspected 30 and the linear camera 232. In this embodiment, the body 10 of the light path restricting structure is disposed between the light source module 22 and the light-splitting unit 231, and is located on a light path of the linear light source projected by the light source module 22. The first surface 101 of the body 10 faces the light source module 22, and the light source inlets 13 face the portion of the light source module 22 where the linear light source is disposed. The second surface 102 of body 10 faces the light-splitting unit 231, and the light source outlets 14 face the light-splitting unit 231. The light channel 15 is located on a linear path between the light source module 22 and the light-splitting unit 231, that is, the light path described above.

The operation module 21 drives the conveying mechanism 24 to drive the object to be inspected 30 to move, and meanwhile, the light source module 22 is started to project the linear light source to the object to be inspected 30. Next, the linear camera 232 captures an image of the object to be inspected 30 by linear scanning. The linear camera 232 gradually transmits the image formed by linear scanning to the operation module 21, and the operation module 21 analyzes the image to determine the defect state of the object to be inspected 30.

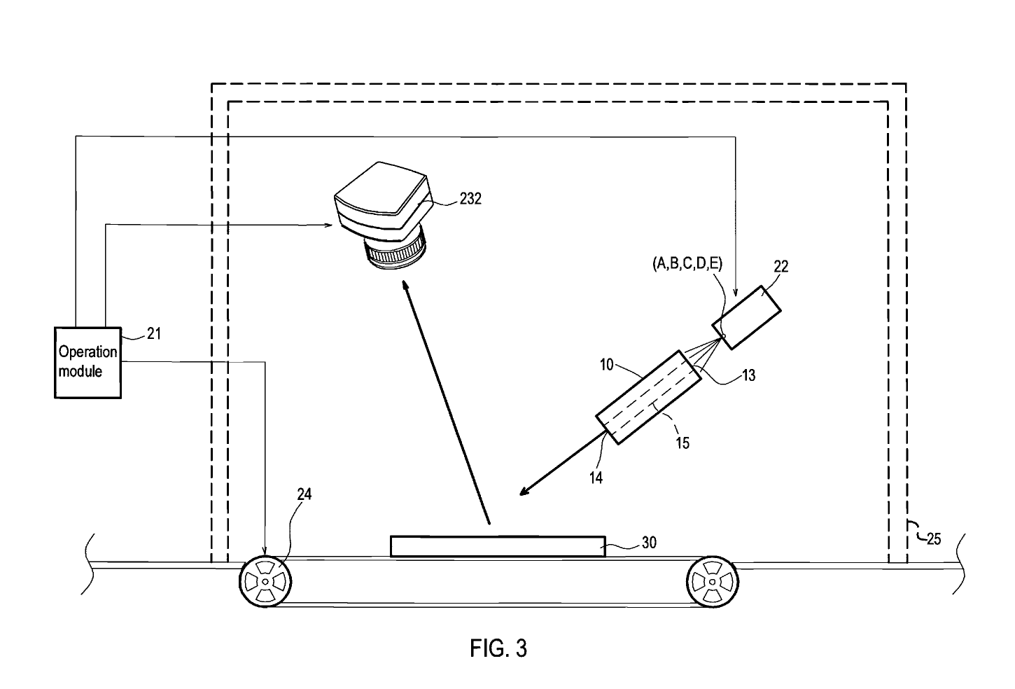

FIG. 3 is a schematic view of a second configuration of a light path restricting structure according to an embodiment of the present invention. Referring FIG. 1 and FIG. 3, the light path restricting structure is applicable in an optical inspection equipment, and the optical inspection equipment includes an operation module 21, a conveying mechanism 24, a light source module 22 for providing a linear light source, a linear camera 232, and a case 25. The case 25 is used for accommodating the light source module 22, the conveying mechanism 24, and the linear camera 232, so as to avoid the formation of undesired images due to influence of other external light sources when the linear camera 232 captures an image of the object to be inspected 30. The light source module 22 is used for providing a plurality of light sources (A, B, C, D, and E) to form a desired linear light source. However, the light source module 22 may also refract the light projected by a point light source with a splitter or a prism to form the linear light source, or may use any light source in combination with a light mask to form the linear light source, but the present invention is not limited thereto, and any light source module capable of forming the linear light source may be used.

As described above, the light source module 22 provides more than one light source (A, B, C, D, and E), so as to form a linear light source projected towards the object to be inspected 30. The light of the light sources (A, B, C, D, and E) is reflected by the object to be inspected 30 to the linear camera 232 for forming an image.

In this embodiment, the body 10 of the light path restricting structure is disposed between the light source module 22 and the object to be inspected 30, and is located on a light path of the light sources (A, B, C, D, and E) projected by the light source module 22. The first surface 101 of the body 10 faces the light source module 22, and the light source inlets 13 face the portions of the light source module 22 where the light sources (A, B, C, D, and E) are disposed. The second surface 102 of the body 10 faces the object to be inspected 30, and the light source outlets 14 face the object to be inspected 30. The light channel 15 is located on a linear path between the light source module 22 and the object to be inspected 30, that is, the light path described above.

The operation module 21 drives the conveying mechanism 24 to drive the object to be inspected 30 to move, and meanwhile, the light source module 22 is started to project the linear light source to the object to be inspected 30. Next, the linear camera 232 captures an image of the object to be inspected 30 by linear scanning. The linear camera 232 gradually transmits the image formed by linear scanning to the operation module 21, and the operation module 21 analyzes the image to determine the defect state of the object to be inspected 30.

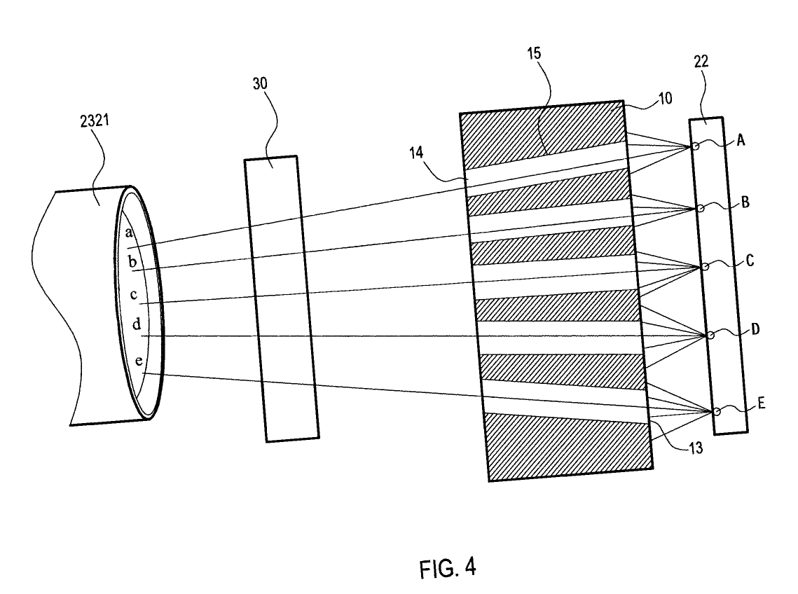

FIG. 4 is a schematic view of light path restriction according to an embodiment of the present invention. As described above, the light path restricting structure is suitable for the configuration of FIG. 2 or the configuration of FIG. 3. No matter which configuration is adopted, the light inlets 13 face the emitting sites of the light sources (A, B, C, D, and E) of the light source module 22, and the light source outlets 14 face the light-splitting unit 231 (FIG. 2) or the object to be inspected 30 (FIG. 3).

In this embodiment, the configuration of FIG. 3 is taken as an example for description, and it is assumed that the light source module 22 is a linear light source emitter, and provides five light sources (A, B, C, D, and E) to form the linear light source described above. When each light source is projected, the light is incident through the light inlet 13, passes through the light channel 15, and then is output through the light source outlet 14. The body 10 maintains the light linearly projected by the linear light sources (A, B, C, D, and E) to the linear camera 232 by means of the light channels 15, or maintains the light linearly projected to the object to be inspected 30 and then reflected to the linear camera 232. Meanwhile, the body 10 shields or absorbs the light at other angles not passing through the light channels 15 by means of the other opaque portions. Therefore, as for FIG. 4, the light output by the linear light source A directly reaches Position a of a lens 2321 of the linear camera 232, the light output by the linear light source B directly reaches Position b of the lens 2321 of the linear camera 232, the light output by the linear light source C directly reaches Position c of the lens 2321 of the linear camera 232, the light output by the linear light source D directly reaches Position d of the lens 2321 of the linear camera 232, and the light output by the linear light source E directly reaches Position e of the lens 2321 of the linear camera 232. Meanwhile, the situation that the light of the light source A reaches Position b, Position c, Position d, or Position e, the light of the light source B reaches Position a, Position c, Position d, or Position e, the light of the light source C reaches Position a, Position b, Position d, or Position e, the light of the light source D reaches Position a, Position b, Position c, or Position e, and the light of the light source E reaches Position a, Position b, Position c, or Position d is reduced, that is, the situation that the same position on the lens 2321 of the linear camera 232 receives the light of multiple light sources at the same time is alleviated.

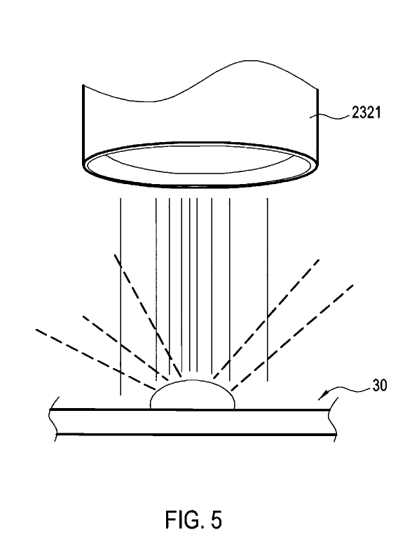

FIG. 5 is a schematic view of light refraction according to an embodiment of the present invention. Referring to FIG. 4 and FIG. 5, as for the object to be inspected 30, the linear camera 232 and the light source module 22, the body 10 shields the light that is projected to the object to be inspected 30 and is reflected by the object to be inspected 30 to generate low-angle reflected light (dotted part in FIG. 5), so as to alleviate the situation that low-angle reflected light enters the lens 2321 of the linear camera 232. Thus, the contrast of the image formed by the linear camera 232 is increased, the image formed by the linear camera 232 may present the concave-convex state of the surface of the object to be inspected 30 clearly, and the formed image highlights protruding portions and depressed portions on the object to be inspected 30, for example, distribution of elements, line pattern of the circuit, coating situation and sealant configuration, thus facilitating the operation module 21 to analyze the defect state of the object to be inspected through the image.

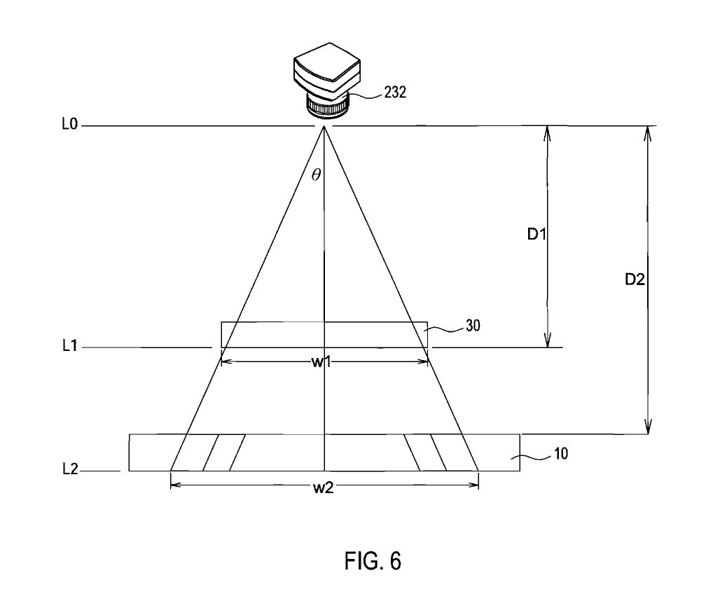

FIG. 6 is a schematic view of range estimation of an inclined angle of light channels of a light path restricting structure according to an embodiment of the present invention. Position L0 indicates a position of the linear camera 232, Position L1 indicates a position of the object to be inspected 30, and Position L2 indicates a position of the body 10 of the light path restricting structure.

Assuming that Distance D1 from the lens of the linear camera 232 to the object to be inspected 30 is 430.9 mm, Distance D2 from the body 10 to the lens of the linear camera 232 is 580.9 mm, the resolution required by the object to be inspected 30 is 25 μm, the image formed by the linear camera 232 has 8192 pixels, and the measurement range w1 of the linear camera 232 for shooting the object to be inspected 30 is 8192×25=204, 800 μm=204.8 mm, the range of an angle θ of the light channel 15 of the body 10 is calculated as follows:

tan θ=(½×measurement range w1 of the linear camera)/(Distance D1 from the lens of the linear camera to the object to be inspected)=(½×204.8)/430.9=0.238

θ=13.38 degrees

Based on the above, it can be estimated that the range of the inclined angle of the body 10 is +13.38 to −13.38 degrees, and thus a schematic view of a triangular projection range of the light source from the linear camera 232 to the body 10 can be constructed (that is, FIG. 6).

Next, as the distance from the body 10 to the lens 2321 is 580.9 mm, and the measurement range w1 of the linear camera 232 is 204.8 mm, it can be derived according to the principle of similar triangles that the largest range w2 of the light angle of the light that is capable of passing through the body 10 is 204.8×580.9/430.9=276.1 mm. Thus, the light path restricting structure meeting the above requirements is designed, but the present invention is not limited thereto, and light path restricting structures with the same architecture but different component specifications may also be designed based on the same concept under different equipment conditions.

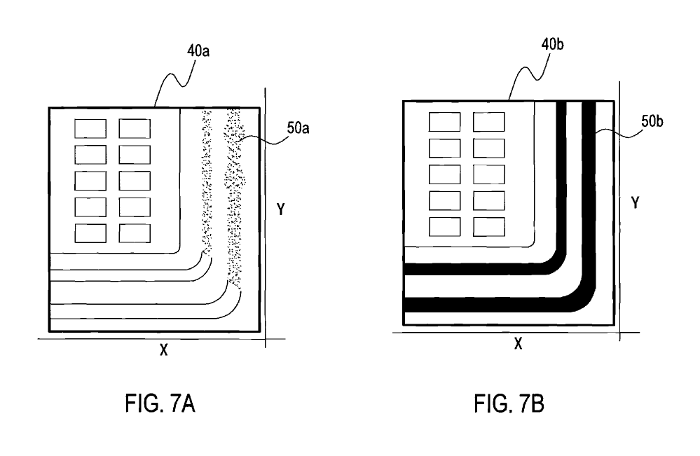

FIG. 7A and FIG. 7B are schematic views of formed images according to an embodiment of the present invention. Referring to FIG. 7A and FIG. 7B as well as FIG. 2 or FIG. 3, in this embodiment, an object to be inspected 30 having sealant lines is taken as an example for illustration. As shown in FIG. 7A and FIG. 7B, it is assumed that the object to be inspected 30 is drived to move in a direction parallel to Y axis, and the shape of the light sources (A, B, C, D, and E) projected by the light source module 22 and the shooting range of the linear camera 232 are linear and parallel to X axis. If the body 10 described above is not used, an image 40a formed by the linear camera 232 is as shown in FIG. 7A. Due to poor contrast of the image 40a, a sealant pattern 50a in the Y axis is in a blurred state, and the concave-convex state on the object to be inspected 30 cannot be highlighted, which does not facilitate the operation module 21 to perform defect inspection on the object to be inspected 30.

When the body 10 described above is used, the body 10 merely maintains the linear light paths from the light source module 22 to the linear camera 232 or the object to be inspected 30. An image 40b formed by the linear camera 232 is as shown in FIG. 7B, in which due to good contrast of the image 40b, a sealant pattern 50b in the Y axis is presented as clear lines, which facilitates the operation module 21 to perform defect inspection on the object to be inspected 30.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A light path restricting structure, applicable in an optical inspection equipment, wherein the optical inspection equipment comprises a light source module for providing a linear light source, a light-splitting unit, a conveying mechanism, a linear camera, an operation module for driving the linear camera, the conveying mechanism and the light source module, and a case, the light-splitting unit is used for refracting light of the linear light source to an object to be inspected and the linear camera, the light source module, the light-splitting unit, the conveying mechanism and the linear camera are disposed in the case, the object to be inspected is drived by the conveying mechanism to move, and the light path restricting structure is disposed between the light source module and the light-splitting unit, the light path restricting structure comprising:
a body, comprising a first surface facing the light source module and a second surface facing the light-splitting unit; and
a plurality of light channels, disposed in the body, wherein each light channel is linear tubular, and each light channel comprises a light source inlet disposed on the first surface and a light source outlet disposed on the second surface, positions of the light source inlets are corresponding to a light emitting site of the linear light source, and the light source outlets are disposed corresponding to the light-splitting unit.

2. The light path restricting structure according to claim 1, wherein a cross-sectional shape of each light channel is a circle or a polygon.

3. The light path restricting structure according to claim 2, wherein the polygon is a triangle, a quadrilateral, a pentagon, or a hexagon.

4. The light path restricting structure according to claim 1, wherein the body is formed by boning a first block and a second block together, and a surface of the first block has the light channels with open space disposed thereon, and the light channels are disposed between the first block and the second block when the first block and the second block overlap.

5. The light path restricting structure according to claim 1, wherein a material of the body is a light absorbing material or an opaque material, for shielding or absorbing divergent light at other angles not passing through the light channels.

6. The light path restricting structure according to claim 1, wherein the body and the light channels are integrated to form a unity.

7. A light path restricting structure, applicable in an optical inspection equipment, wherein the optical inspection equipment comprises a light source module for projecting a linear light source to an object to be inspected and a linear camera for receiving reflected light formed by projecting the linear light source to the object to be inspected, a conveying mechanism for driving the object to be inspected to move, an operation module for driving the linear camera, the conveying mechanism and the light source module, and a case, the light source module and the linear camera are disposed in the case, and the light path restricting structure is disposed between the light source module and the object to be inspected, the light path restricting structure comprising:
a body, comprising a first surface facing the light source module and a second surface facing the object to be inspected; and
a plurality of light channels, disposed in the body, wherein each light channel is linear tubular, and each light channel comprises a light source inlet disposed on the first surface and a light source outlet disposed on the second surface, positions of the light source inlets are corresponding to a light emitting site of the linear light source, and the light source outlets are disposed corresponding to the object to be inspected.

8. The light path restricting structure according to claim 7, wherein a cross-sectional shape of each light channel is a circle or a polygon.

9. The light path restricting structure according to claim 8, wherein the polygon is a triangle, a quadrilateral, a pentagon, or a hexagon.

10. The light path restricting structure according to claim 7, wherein the body is formed by bonding a first block and a second block together, and a surface of the first block has the light channels with open space disposed thereon, and the light channels are disposed between the first block and the second block when the first block and the second block overlap.

11. The light path restricting structure according to claim 7, wherein a material of the body is a light absorbing material or an opaque material, for shielding or absorbing divergent light at other angles not passing through the light channels.

12. The light path restricting structure according to claim 7, wherein the body and the light channels are integrated to form a unity.
